(19) United States
(12) Patent Application Publication
(10) Pub. No.: US 2017/0048302 A1
(43) Pub. Date: Feb. 16, 2017

(54) STATIC STATISTICAL DELTA DIFFERENCING ENGINE

(71) Applicant: TransferSoft, Inc., Culver City, CA (US)

(72) Inventor: Attila Mark SZILAGYI, San Pedro, CA (US)

(21) Appl. No.: 14/822,765

(22) Filed: Aug. 10, 2015

(51) Int. Cl. H04L 29/08

(52) U.S. Cl. CPC H04L 67/06; H04L 67/1097; H04L 67/02

(57) ABSTRACT

A method, an apparatus, and a computer program product for accelerating network data transfer are provided. A fingerprint map (FM) of fingerprints for representing a file is created at a source node and written to a memory. The file is transferred to a destination node. When a modified version of the file is available at the source, data representing a difference between the FM and the modified version is generated. In response to a request to transfer the file to the destination or a predetermined condition, the data representing the difference is transmitted to the destination along with an indication that the modified version can be reproduced using the file and the data.

### FIELD

The present disclosure relates generally to data systems, and more particularly, to techniques for accelerating data transfer and duplication.

### BACKGROUND

Current file transfer technologies include the file transfer protocol (FTP). FTP is a protocol that enables a user to retrieve files from a remote location over a TCP/IP network. The user runs an FTP client application on a local computer, and an FTP server program resides on a remote computer. The user logs into the remote FTP server using a login name and password, which the server then authenticates. File transfers may also be conducted using hypertext transfer protocol (HTTP) in the form of a file download.

File transfers using FTP, HTTP and similar technologies are often inefficient. In the case where a large file is periodically modified or updated, a user will often repeatedly download over time the modified versions of the file. This is true even where the changes to the file are relatively small in comparison to the file size. The repetitive nature of downloads for such files changing over time often results in significant chunks of the same data being needlessly transferred across a network, producing latencies and clogging network bandwidth. The potentially deleterious effect of these repeated transfers often becomes more pronounced when the same embedded images or graphics persist in the file modified over time, or when large blocks of text in modified versions contain relatively insubstantial modifications.

Where many users are involved, this phenomenon can create a bottleneck. The result is that much of the same data ends up being repeatedly transferred over the network. Even where conventional compression techniques on individual files are used, the core problem of sending redundant chunks of data via the transmission of multiple versions of the same file is largely unaddressed. As the number of users, transfers and file modifications increase, the available bandwidth is taxed, resulting in network inefficiencies.

These and other limitations are addressed in the present disclosure.

### SUMMARY

In an aspect of the disclosure, a method, a computer program product, and an apparatus for transferring data are provided. The apparatus includes a memory having a first file stored therein, a processor coupled to the memory and configured to create a first fingerprint map (FM) corresponding to the first file, write the first FM to the memory and generate, using a second file and the first FM, data representing a difference between the first file and the second file, wherein the data and the first file are sufficient to generate the second file, and a transceiver configured to transmit the data and the first file over a network to a destination node.

In another aspect of the disclosure, the apparatus includes a memory having a plurality of files stored therein, a processor coupled to the memory and configured to create a cumulative fingerprint map (FM) corresponding to the plurality of files, write the cumulative FM into the memory; and generate, using the cumulative FM and at least one file separate from the plurality of files, data representing a difference between the plurality of files and the at least one separate file, wherein the data and the plurality of files are sufficient to generate the at least one separate file, and a transceiver configured to transmit the data and the plurality of files over a network to a destination node.

In another aspect of the disclosure, the computer program product including a non-transitory computer-readable medium has computer executable code for creating a first fingerprint map (FM) corresponding to a first file, writing the first FM to a memory, generating, using a second file and the first FM, data representing a difference between the first file and the second file, wherein the data and the first file are sufficient to generate the second file, and transmitting the data and the first file via a transceiver over a network to a destination node.

In another aspect of the disclosure, the computer program product including a non-transitory computer-readable medium has computer executable code for creating a cumulative fingerprint map (FM) corresponding to a plurality of files, writing the cumulative FM into a memory, generating, using the cumulative FM and at least one file separate from the plurality of files, data representing a difference between the plurality of files and the at least one separate file, wherein the data and the plurality of files are sufficient to generate the at least one separate file; and transmitting the data and the plurality of files via a transceiver over a network to a destination node.

Additional advantages and novel features will be set forth in part in the description that follows, and in part will become more apparent to those skilled in the art upon examination of the following or upon learning by practice thereof.

### BRIEF DESCRIPTION OF THE DRAWINGS

FIG. 1 is a conceptual diagram illustrating a file transfer using delta differential compression based on static mapping.

FIG. 2 is a flow diagram illustrating a file transfer using delta differential compression based on static mapping.

FIG. 3 is a conceptual diagram illustrating a file transfer using delta differential compression based on on-the-fly mapping.

FIG. 4 is a flow diagram illustrating a file transfer using delta differential compression based on on-the-fly mapping.

FIG. 5 is a conceptual diagram illustrating a file transfer using delta differential compression based on cumulative mapping.

FIG. 6 is a flow diagram illustrating a file transfer using delta differential compression based on cumulative mapping.

FIG. 7 is a diagram illustrating an engine for effecting file transfers using delta differential compression.

FIG. 8 is a diagram illustrating an apparatus for file transfers using delta differential compression.

FIG. 9 is a conceptual diagram illustrating a technique for creating a fingerprint map of a file.

FIG. 10 is a flow diagram illustrating a technique for creating a fingerprint map of a file.

FIG. 11 is a flow diagram illustrating a technique for computing a delta of a file and a fingerprint map of another file.

FIG. 12 is a flow diagram illustrating a technique for performing delta differencing on a raw data stream.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of systems for data transfer will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

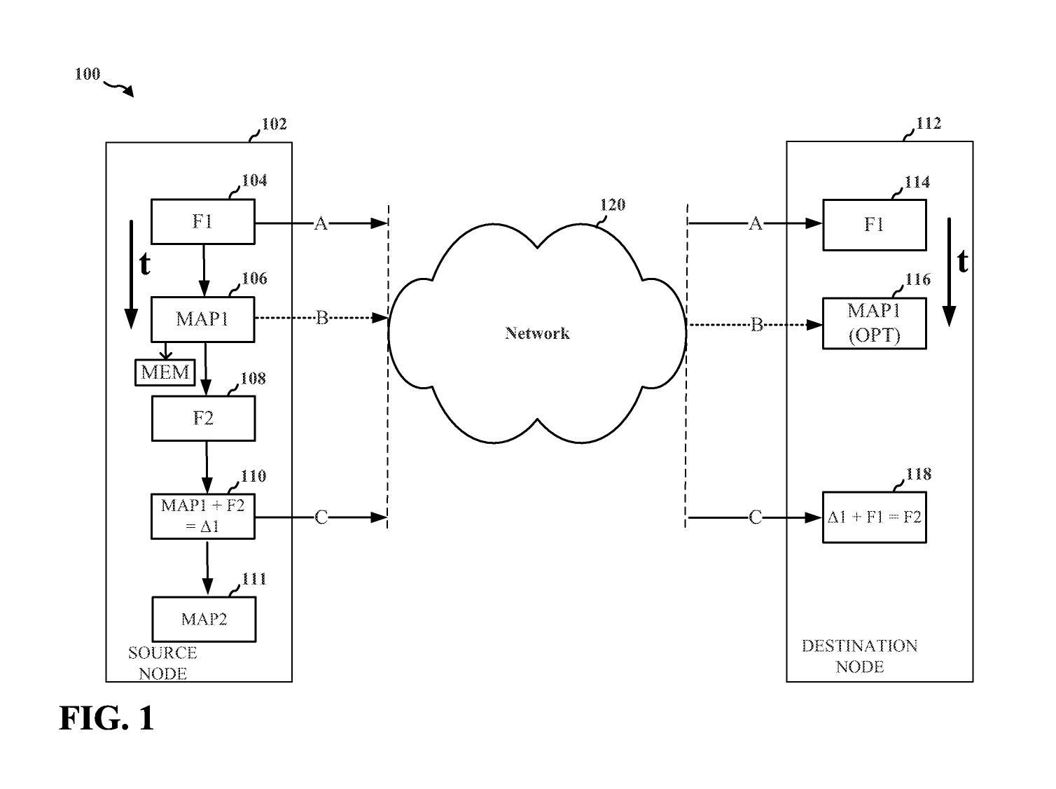

FIG. 1 is a conceptual diagram 100 illustrating a file transfer using delta differential compression based on static mapping. FIG. 1 represents one example of a static mapping mode. In an embodiment, as files are transferred, a map of file fingerprints is stored in a hidden file at the source node. As described herein, a static fingerprint map may consume on average less than 0.1% of the file size. Subsequently, when files are changed and designated for transfer, only the changed data is sent, significantly reducing bandwidth utilization and speeding the remote file synchronization. Concurrently, the locally stored static fingerprint map may be updated to reflect the now current file versions.

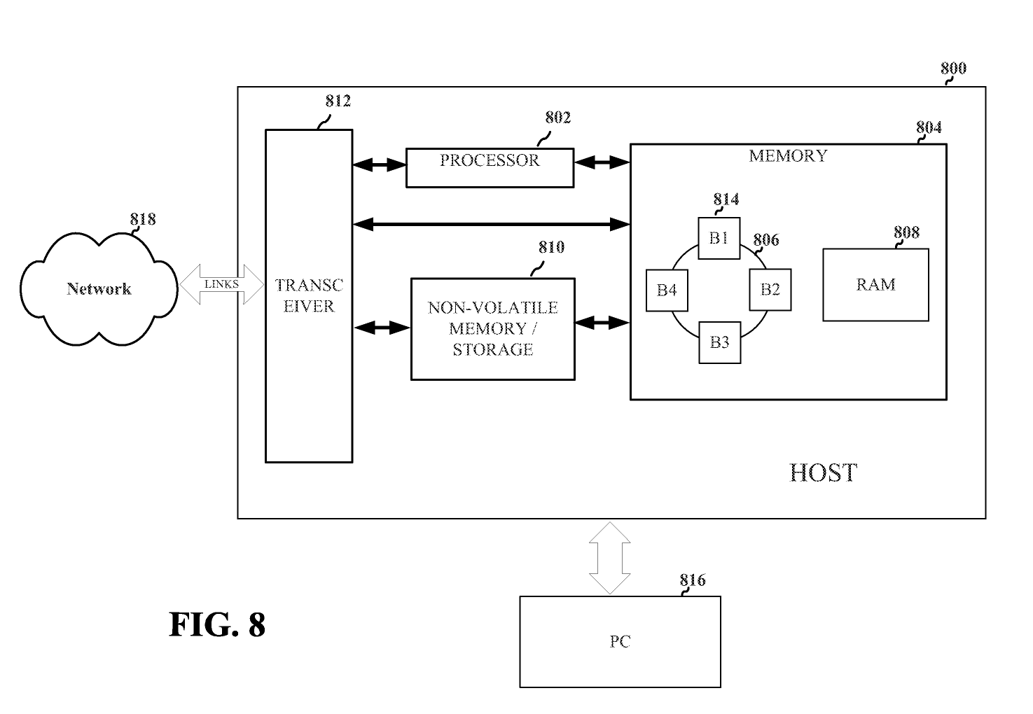

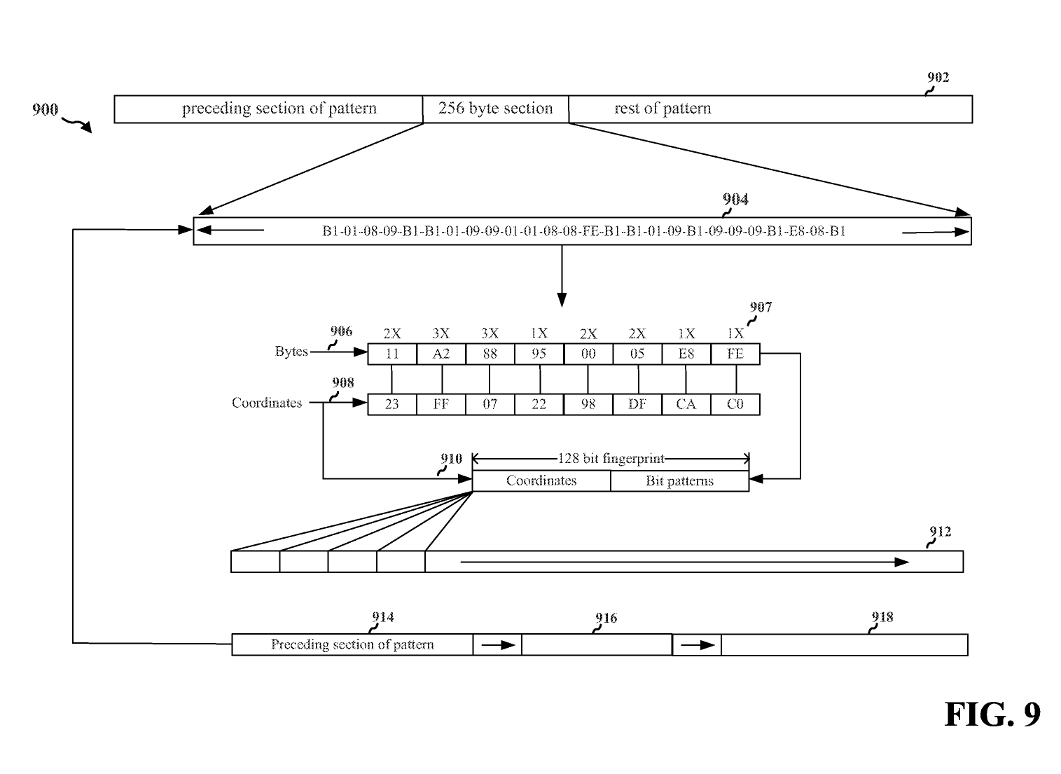

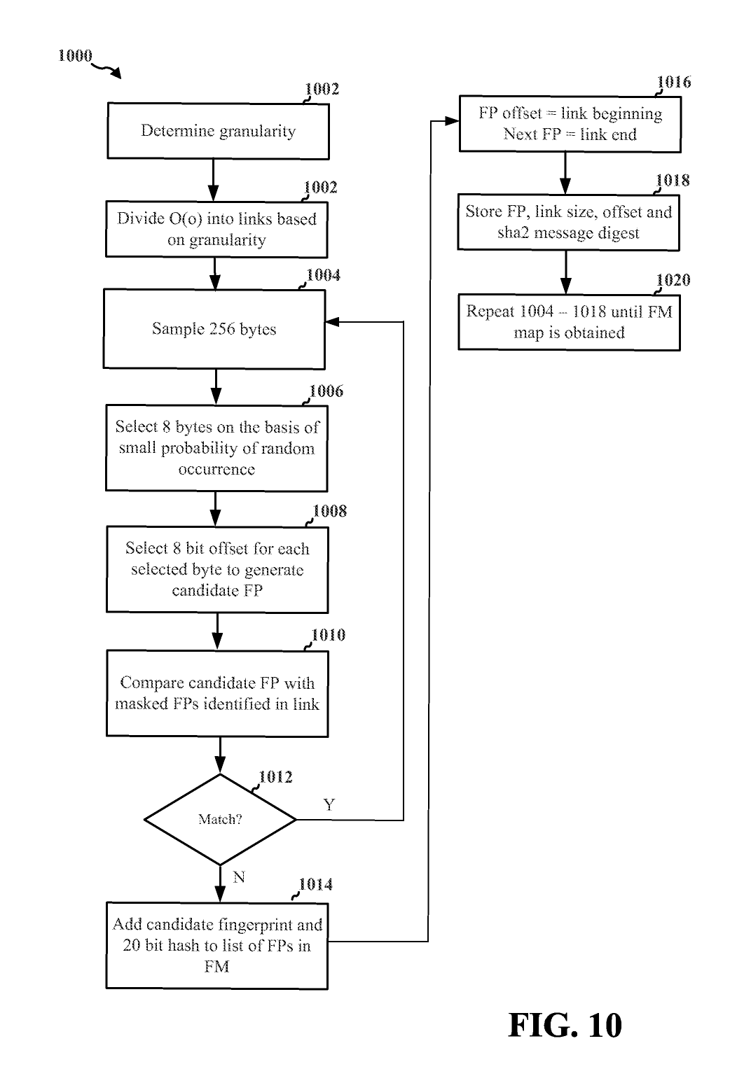

Block 102 represents a source node, such as the apparatus 800 for transferring files in FIG. 8. The source node 102 may represent a server or other computing device, or a collection of computing devices. Block 112 represents a destination node. Blocks 104, 106, 108, 110 and 111 represent events that may occur within source node 102 and these events may occur in the order of time from lower to higher reference numerals, as illustrated by the vertical arrow designated by “t”. Similarly, blocks 114, 116 and 117 represent events that may occur within destination node 112 and these events may also occur in the order of time from lower to higher numbers. Beginning at 104, a file F1 is received at source node. In other configurations, F1 may already be resident at the source node. F1 may be stored in a memory, such as a non-volatile memory, at source node 102. At 106 a fingerprint map MAP1 is generated using an appropriate algorithm, as discussed in greater detail below with reference to FIGS. 9 and 10. Thereupon, MAP1 is stored in memory MEM at source node 102.

As illustrated in FIG. 1 by the arrow designated A, F1 at that time may be transferred to the destination node 112 via network 120. The arrival of F1 at destination node 112 is illustrated by the corresponding arrow designated A and block 114. In other configurations, source node 102 transfers MAP1 to destination node 112 as illustrated by the dotted arrow designated B and block 116. As illustrated in block 116 at destination node 112, the transfer of MAP1 is optional and may be performed in lieu of or in addition to the transfer of F1 to destination node 112. In still other embodiments, F1 may be transferred to destination node 112 as indicated by block 114, but then the destination node 112, rather than the source node 102, may create the FM (MAP1) corresponding to F1 and then may transmit MAP1 back to the source node 112.

In the above illustration, there is an original version of F1 (104) and a copy of F1 (114) where the copy was either transferred directly from source node 102, was reproduced from MAP1 and other data or was made available by some other means.

The technique of FIG. 1 involves computing a fingerprint map of file F1, which is discussed with reference to FIGS. 9 and 10. Because creating the fingerprint map is generally one of the initially steps, one embodiment of a technique for creating the fingerprint map is now described. FIG. 9 is a conceptual diagram 900 illustrating a technique for creating a fingerprint map of a file. A file or a section of a file may be regarded as a pattern of bytes known as fingerprints. A fingerprint may include a well-defined relatively short length data packet sampled at an arbitrary position from a data stream. The fingerprints may represent sections of a file or data stream and may be selected on the basis of their relative “uniqueness” within the fingerprint map. An example of a short fingerprint is one that is much shorter than the length of the data stream itself but, in one configuration, not longer than 1024 bits. The fingerprinting of a stream map includes finding all the qualifying fingerprints throughout the stream. A fingerprint map of a stream includes the collection of the fingerprints and their positions within that stream. Finding a quality fingerprint is generally dependent upon the entropy (degree of randomness) of the stream.

Using an appropriate algorithm as illustrated below, large files may be represented as one or more maps of fingerprints where the map is comparatively smaller than the original file, where the fingerprint map may be used to identify similarities within files.

A file in general consists of any number of bytes that can be represented by values in the range {00h . . . FFh}. If a subset of byte patterns can be identified whose probability of random occurrence is very small and it is ensured that the patterns occur once, such patterns may be used as fingerprints of the file. A fingerprint is similar to a checksum in this regard, except that it is not computed but created from the file itself.

Four criteria for a statistically qualifying fingerprint include (i) minimal frequency of occurrence of the fingerprint within the data stream, (ii) minimal frequency of occurrence of the fingerprint with the fingerprint map, (iii) a high entropy (i.e., highly random bits), and (iv) low collision probability. In the context of the 128-bit fingerprinting algorithm discussed in greater detail below, the following general process may be used to gather the fingerprint map of a stream:

1. Divide the stream into fragments, which gives the sample window length.

2. Sample a 128 bit packet in window of data, which represents the 128 bit candidate fingerprint.

3. Check the 128 bit candidate fingerprint for minimum entropy.

4. Check the 128 bit candidate fingerprint for low frequency.

5. If the conditions are satisfied and the fingerprint meets a quality threshold, shift the window by 128 bits and repeat from step 2.

FIG. 9 shows a section of a file comprising a pattern of bytes 902. Byte pattern 902 includes a preceding section, a 256 byte section, and a remaining section. In one configuration, each adjacent 256 byte section is consecutively analyzed. An exemplary 128 bit fingerprint algorithm searches for and selects eight bytes each within a 256 byte boundary from a given pattern by using a statistical approach that identifies uniqueness within the pattern. For example, a portion 904 of the 256 byte section is shown in FIG. 9. In the portion 904 as well as the entire 256 byte section being analyzed, FE and E8 hex only occur once. Based on their minimal occurrence within the pattern, the following bytes 906 are selected including FE and E8, and their coordinates 908 identifying their relative position in the pattern are packed into another 8 byte array. The occurrence field 907 in this example indicates the number of occurrences of the respective bytes 906 in the pattern. As will be appreciated by one skilled in the art, a general objective of the fingerprint selection algorithm is to ensure that the selected fingerprints do not occur anywhere else in the pattern so as to satisfy the relative “uniqueness” of the fingerprint within the pattern.

The bytes 906 and coordinates 908 are placed into a candidate 128-bit fingerprint 910. The candidate fingerprint 910 is then matched against any other corresponding fingerprints selected to date, as shown in pattern 912. In one configuration, a determination of whether a match is present is made at each byte boundary of the original pattern. If a match is found, the candidate fingerprint 910 is discarded and the next 256 byte section of the pattern is analyzed.

Generally, it can be shown that assuming a “normal” distribution of bits in a sample of any size, the probability of occurrence of any given fingerprint is the same, and that probability depends only on the size of the sample. For example, the probability of a 128 bit fingerprint occurring once in a one Terabyte random sample is about 1 in a five hundred million. While the presence of a “normal” distribution of bits is rare in practice with everyday files, matching fingerprints may be eliminated from the map by checking the file for fingerprint repetitions as described above. Once the distribution of a 256 byte sample is analyzed, the byte spectrum may be taken as the basis to select the fingerprint that would have the lowest probability of occurrence if the file had the same distribution as the block sample.

Thus, in the embodiment of FIG. 9 where a preceding 256 byte section 914 is analyzed in the event of a match, the section shifts forward by 256 bytes and the next section 916 is analyzed, followed by the next section 918. The above steps are repeated until the end of the pattern is reached or a suitable fingerprint is found.

In sum, the 128-bit (16-byte) fingerprints are constructed by sampling 256-byte continuous blocks from the file. The coordinates 908 in FIG. 9 represent 8 bit offsets identifying the respective positions of the bytes 906 within the block, as noted above. The 8 bit offsets obtained in this manner also serve as a byte mask. More specifically, when the block is shifted within the file as described with reference to FIG. 9, the mask selects a new set of fingerprint bytes. The fingerprints—i.e., the eight bytes and their respective offsets—are selected by performing statistical analyses of the block to ensure that they meet a high entropy criteria or the lowest probability of random occurrence. Using the offset mask, a fingerprint can be matched with all other fingerprints in the file by byte shifting the block. By searching fingerprints at arbitrary offsets an array of fingerprints that maps the entire file may be obtained.

FIG. 10 is a flow diagram 1000 illustrating a technique for creating a fingerprint map of a file. In the embodiment shown, obtaining the fingerprint map may be effected by first deciding how many fingerprints are required to map the file (1002). The number of fingerprints is known as the granularity. To obtain a better resolution for obtaining a Δ of a file as discussed herein, a higher granularity can be set to obtain more fingerprints. Based on the granularity, the file being mapped is divided into sections referred to herein as links (1002). An example of a link may be the pattern 902 in FIG. 9. While the average size of a link may be arbitrary, its actual size may vary depending on the location where the fingerprints are found. Here, as in FIG. 9, a 256-byte section is sampled (1004) and eight bytes are selected on the basis of a small probability of random occurrence pursuant to the entropy equation being used in the fingerprinting algorithm (1006). After an 8-bit offset is selected for each byte representing a part of the candidate fingerprint (1008), the candidate fingerprint is matched against the rest of the masked fingerprints in the link (1012) and selected if it matches no other. Specifically, if no match is found, the candidate fingerprint is added along with its 20 bit hash value is added to the list of fingerprints in the map (1014). If a match is found, control may return to 1006 or it may proceed to 1016 depending on the algorithm.

The offset at which the fingerprint found marks the beginning of the link, and the next fingerprint will mark the links end (1016). In this manner, each link is assigned a new fingerprint and each new candidate fingerprint is ensured to not match against any previous one, which in turn ensures that each fingerprint occurs only once in the file. In addition to the fingerprint, each link size and offset is also stored along with its sha2 message digest in the fingerprint map (1018). Continuing this technique, an array of fingerprints of the file is obtained (1020). The number of fingerprints may be determined by the number of divisions of the file and the byte entropy of the file. Generally, this number is no more than the granularity selected. The granularity, in turn, may be the predetermined average number of divisions, which in one embodiment is at a minimum ten times the number of expected file changes. The total fingerprint map FM in one embodiment is the total number of fingerprints, array hashes, message digests and link offsets of the original file. The map is sufficient to compute the Δ between the file and any other file, as described further below.

In an embodiment, the fingerprint map is computed using an entropy equation characterized by an alphabet of N letters, whereby for each data chunk a probability is determined that a K length word has less than L number of repeating letters. For a fingerprint of 16 bytes, this problem is solved for L=1 to 16, with K=16 and N=256. The data chunk length may vary depending on the boundary of each identified fingerprint.

In one embodiment, the minimum entropy is defined as the frequency of occurrence of any octet at an 8 bit boundary in the 128 bit fingerprint (128 bit sequence). This frequency of occurrence may be designated as a number range between 1-16 such that the higher the number the lower the entropy and the lower the worth of a fingerprint, and vice versa. If the entropy of a fingerprint is greater than a minimum threshold, it is not a good candidate and another candidate is selected. Based on real world data in the experience of the inventors, the best entropy minimum appears to be around 4 in the 1-16 number range. The given criteria can be mathematically verified based on the minimum entropy and assuming a normal random distribution of bits in a stream. The probabilities of occurrence for the different minimum entropies are set forth in the following tables:

TABLE 1
PROBABILITES FOR FINGERPRINTS
WITH A CERTAIN (E)NTROPY
E = 1: 7.52E−37, <0.00E+00, >= 1.00E+00
E = 2: 6.29E−30, <7.52E−37, >= 1.00E+00
E = 3: 3.48E−25, <6.29E−30, >= 1.00E+00
E = 4: 2.12E−21, <3.48E−25, >= 1.00E+00
E = 5: 3.41E−18, <2.12E−21, >= 1.00E+00
E = 6: 2.13E−15, <3.41E−18, >= 1.00E+00
E = 7: 6.40E−13, <2.14E−15, >= 1.00E+00
E = 8: 1.04E−10, <6.42E−13, >= 1.00E+00
E = 9: 9.88E−09, <1.05E−10, >= 1.00E+00
E = 10: 5.76E−07, <9.99E−09, >= 1.00E+00
E = 11: 2.12E−05, <5.86E−07, >= 1.00E+00
E = 12: 4.94E−04, <2.18E−05, >= 1.00E+00
E = 13: 7.24E−03, <5.16E−04, >= 9.99E−01
E = 14: 6.40E−02, <7.76E−03, >= 9.92E−01
E = 15: 3.09E−01, <7.17E−02, >= 9.28E−01
E = 16: 6.20E−01, <3.80E−01, >= 6.20E−01

TABLE 2
BYTES TO SAMPLE UNTIL THERE BECOMES 50%
CHANCE OF FINDING FP-128 LESS THEN E
E < 2: 12786308680337326080.00 EBytes
E < 3: 1530270711808.00 EBytes
E < 4: 27641568.00 EBytes
E < 5: 4541.08 EBytes
E < 6: 2.82 EBytes
E < 7: 4.67 PBytes
E < 8: 15.71 TBytes
E < 9: 98.74 GBytes
E < 10: 1.03 GBytes
E < 11: 18.05 MBytes
E < 12: 497.89 KBytes
E < 13: 20.99 KBytes
E < 14: 1.39 KBytes
E < 15: 149 Bytes
E < 16: 23 Bytes

In some situations, acceptable approximations may be made. Finding quality fingerprints cannot always be guaranteed as it is highly dependent upon the byte entropy of the file. For example, there may be large sections of a file consisting of only a few different bytes, and long sequences of repeating bytes. In many embodiments, the 128 bit fingerprint is strong down to a minimum of 4 different bytes in the maximum separation range of 256 bytes. At this or greater separation range, however, the data may become extremely compressible. Thus, while fingerprinting becomes progressively more difficult to find in the file, the file's compressibility may increase by magnitudes. In the event the fingerprinting algorithm identifies this situation, in one configuration, the algorithm may simply skip analysis of the entire link at issue because the link does not meet the minimum entropy requirement. Thereupon, the link may be marked as “compressible” and its byte statistics may be stored in the FM (MAP1 in FIG. 1) instead of its checksums. In an embodiment, no actual compression takes place at the FM analysis stage. Instead, the compression is performed subsequently when the Δ is computed as described below.

It is assumed for the purposes of this illustration that a number of changes or updates are made to F1, whether at source node 102 or otherwise, to produce file F2 as reflected at block 108. As is often the case, updated file F2 may contain large amount of redundancies. The redundancies may also consume a comparatively high amount of the overall file space. Examples of redundancies may include images, color graphics, and blocks of identical text. The greater the file size and the greater the number of redundancies, the greater the savings of bandwidth that can be achieved. Referring back to FIG. 1, at block 110, a file (here, Δ1) is generated which is a computation of the difference between F2 and MAP1. In some embodiments F1 may be used in lieu of MAP1 to compute the difference.

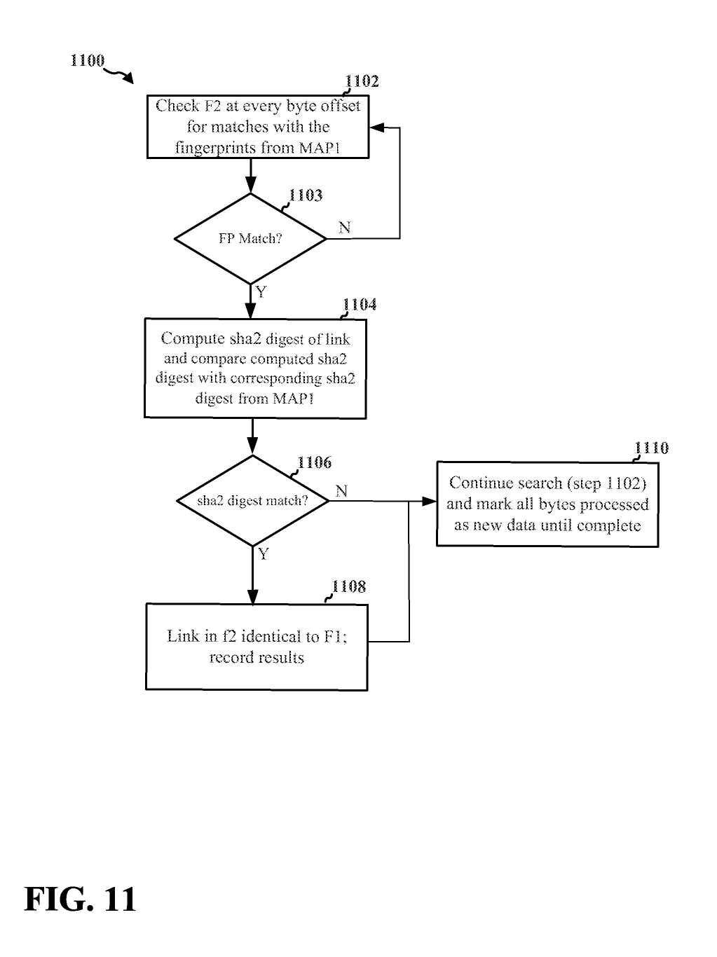

In one embodiment, Δ1 is obtained by first checking F2 at each byte offset of the file for matches with the fingerprints of MAP1. FIG. 11 is a flow diagram 1100 illustrating a technique for computing a delta (Δ) of a file and a fingerprint map of another file. The computation of Δ may commence by checking F2 at every byte offset for matches with the fingerprints from MAP1 (1102). This search for matches may be expedited by using the 20 bit fingerprint hashes stored earlier in connection with the creation of MAP1. If a fingerprint match is found (1103), it is next determined whether the linked fingerprint also matches. This determination may be accomplished by using the stored offset of the adjacent fingerprint. If the stored offset also matches, it is likely that an unmodified link has been found. This is true because the probability that the fingerprint occurred as a result of random chance is extremely small, and the probability of two matching fingerprints being present at the given distance apart is even smaller. Nevertheless, to ensure that the link is identical to the original link in F1, the sha2 digest of the link may be computed and compared with the corresponding sha2 digest stored in connection with the creation of MAP1 (1104). If a match exists it may be concluded that the portion of the file (link) is identical to the original (1108).

While the technique described in this embodiment does not guarantee this conclusion to a certainty (such a guarantee would generally require a byte to byte comparison), the conclusion is likely in view of the very small collision chance of the sha2 digest. Furthermore the chance that an sha2 collision occurs while the fingerprints themselves match is even smaller.

In the event that the sha2 digests do not match, the search for matching fingerprints continues, and all bytes that are processed are marked as new data (1110). Also, if an adjacent fingerprint does not match, all bytes processed continue to be marked as new data. After processing the remainder of F2 in this manner, the changes between F1 and F2 are identified and the unmodified links are discovered. The sum of the new data and the unmodified links is A, which can be applied to MAP1 to obtain F2.

In an embodiment, during the delta processing where certain portions of F2 are found to be compressible, they may be encoded with a run-length-encoded (RLE) compression formula, which can achieve an extremely high compression ratio. The degree of compressibility may be high in view of the fact that the byte entropy may be required to get very low before the fingerprinting fails for that portion. For example, a repeating pattern of 1 Kbyte may be compressed to 100:1 by RLE, and the compressed data is than added to Δ1. The described algorithms are easily tunable and scale well for multiple CPU cores. The fingerprint mapping may be computed simultaneously with the delta or from the backup copy of the file. How and when the delta is applied depends on the situation and may be implemented separately depending on the applications needs. The minimum link size and the fingerprint range are tunable to accommodate smaller files, but the algorithm is well suited for files greater than 1 Mb. In one configuration, the default and maximum fingerprint range is 256 bytes, which is the maximum distance between two fingerprint bytes. Compression is optional but for sparse files it may add significant additional benefits for accelerating file transfer operations.

Referring again back to FIG. 1, now that Δ1 has been computed, Δ1 may be transferred as a data stream or a file (or part of another file or file set) over network 120 to the destination node 112, as indicated by the arrows marked as C. Assuming the destination nodes are not preconfigured to correctly interpret the file containing Δ1, then in some embodiments the source node 102 may transmit an indication to the destination node 112 that destination node 112 may reproduce F2 using the file containing Δ1 and MAP1. This indication, if not predetermined, may result from information contained in the Δ1 file, or in a separate file or data transmission.

At this point in time, destination node 112 has the Δ1 and F1 (or MAP1). Thereupon, destination node 112 is able to rapidly compute F2 based on a standard application of Δ1 to F1 (block 118).

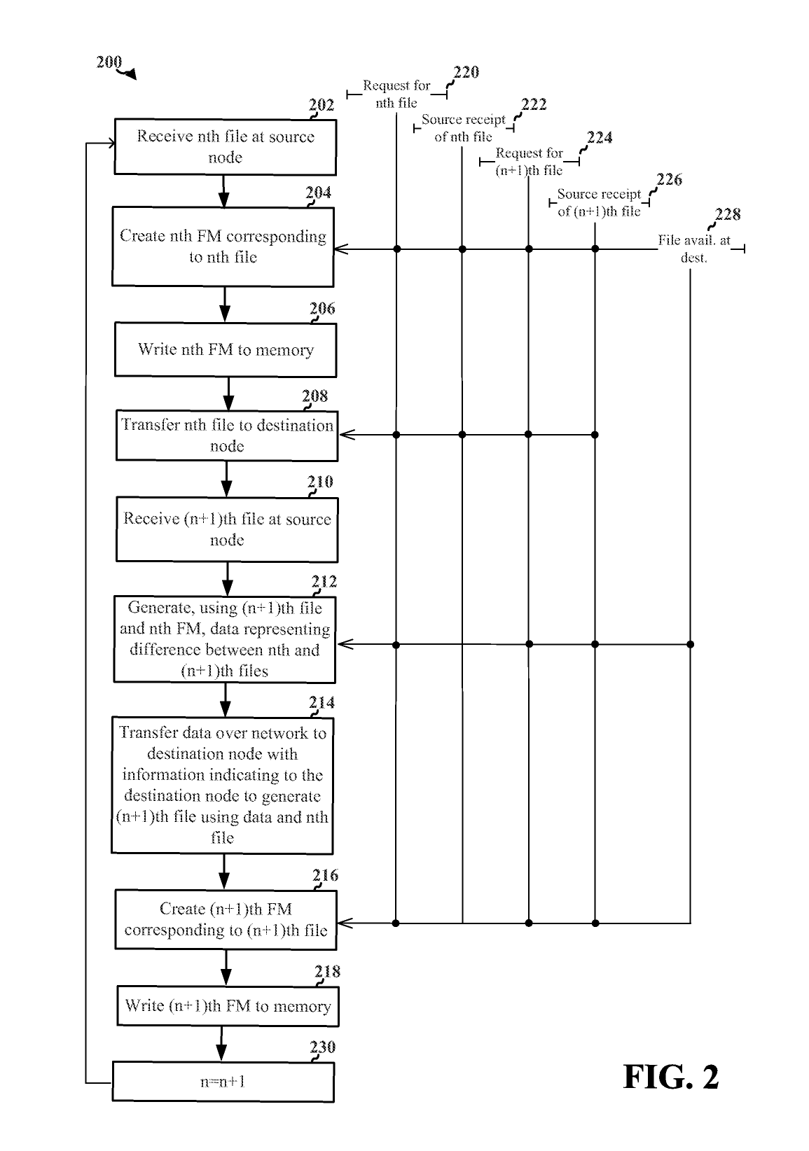

FIG. 2 is a flow diagram 200 illustrating a file transfer using delta differential compression based on static mapping. In FIG. 2, the delta differential file engine may operate on an arbitrary number of n files. It is assumed for purposes of simplicity that an (n=1) file represents an updated or modified version of an nₜₕ file, or otherwise represents a separate file with possible similarities so as to justify the use of delta compression as describe herein. An nₜₕ file is received at a source node such as source node 102 of FIG. 1 (202). Source node 102 thereupon creates an nₜₕ FM corresponding to the nₜₕ file (204). In alternative embodiments, the nₜₕ FM may be created by the destination node 112 and transmitted back to source node 102. The nₜₕ FM is written to memory for use in subsequent operations (206). The nₜₕ file (and/or the nₜₕ FM) is transferred to a destination node, such as destination node 112 of FIG. 1 (208). Subsequently, an (n+1)ₜₕ file is received or otherwise made available at source node 102 (210). The source node 102 generates, using the (n+1)ₜₕ file and the nₜₕ FM, an nₜₕ Δ or data representing a difference between the nₜₕ file and the (n+1)ₜₕ file (212). The source node 102 transfers the data over a network to destination node 112 along with an indication to destination node 112 to generate the (n+1)ₜₕ file using the nₜₕ Δ (i.e., the data) and the nₜₕ file (214). Thereafter, the source node 102 creates an (n+1)ₜₕ FM corresponding to the (n+1)ₜₕ file (216) and saves the (n+1)ₜₕ FM to memory (218) for use in a subsequent delta operation. The process may be repeated (230) or varied as additional files are received that qualify for delta compression.

A number of alternative embodiments may be contemplated in view of FIGS. 1 and 2 and may vary depending on, for example, the manner in which files at the source node are determined to be updated or modified versions of other files, or otherwise determined to be candidates for computing deltas.

In FIG. 2, the fields 220, 222, 224, 226, and 228 represent examples of various events. Field 220 represents an event where a request has been made, such as by a destination node (or in some embodiments by the source node or another external node), to transfer the nₜₕ file to the destination node. Field 222 represents an event where the source node has received the nₜₕ file or the nₜₕ file is otherwise made available at the source node. Field 224 represents an event where a request has been made, such as by the destination node (or in some embodiments by the source node or another external node), to transfer the (n+1)ₜₕ file to the destination node. Field 226 represents an event where the source node has received the (n+1)ₜₕ file or the (n+1)ₜₕ file is otherwise made available at the source node. Field 228 represents an event where the file has been received at the destination node, or is otherwise available at the destination node (for example, an FM of the file may have been received or generated at the destination node). The small circles in FIG. 2 and the corresponding arrows constitute a matrix representing that in certain illustrative embodiments, the identified steps may be performed in response to the identified events. By way of example, in some situations a FM may be created (204) in response to the request for the file (220), the receipt at the source node of the file (222), a request for a modified version of the file (224), the receipt at the source node of the modified version of the file (226), or the availability of the file at the destination node (228), or some combination thereof. The illustrated events and resulting steps are exemplary in nature, and other implementations may be equally suitable depending on the application.

Whether any given file is a candidate for delta compression as described herein may be determined using any of a variety of methods at the source node. For example, certain fields or metadata corresponding to a document may be retrieved at the source node to determine whether the file has been identified as an updated or modified version of an existing file. In another configuration, the document title may be provided in an identifiable format. Alternatively, a basic comparison of the content of a candidate file may be made with one or more existing files to determine its suitability for delta compression.

In another embodiment where a file is subsequently updated a number of times, the source node may only maintain and save a FM of the original file, and may reuse the FM and recomputed respective deltas for each subsequent modified version of the file. Alternatively, the source node may create a new FM of each iteration of the file.

By using the techniques disclosed herein, substantial bandwidth savings can be achieved since only the changes to documents need to be transmitted over the network to a destination. The FM may be maintained in memory at the source node for use in computing deltas corresponding to future modifications.

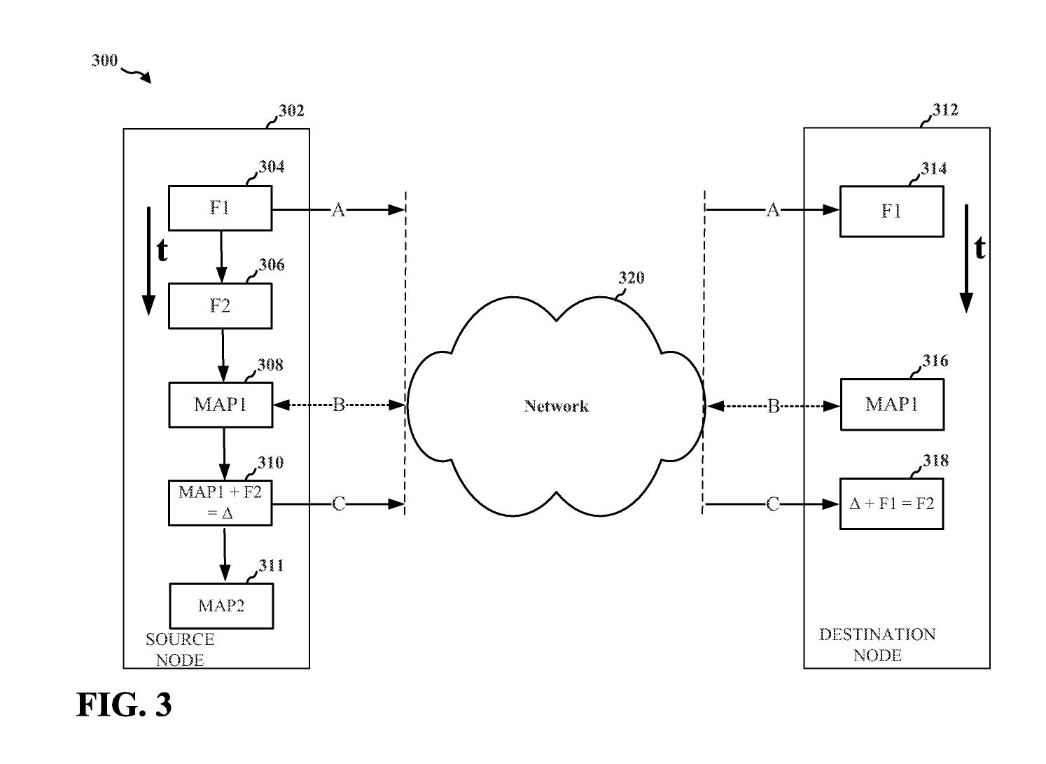

FIG. 3 is a conceptual diagram 300 illustrating a file transfer using delta differential compression based on on-the-fly mapping. In short, unlike the static mapping as described in FIGS. 1 and 2 in which the FM is created and stored in memory for use in accelerating transfers of updated files, the approach in FIG. 3 involves creation of the FM “on-the-fly” when either the modified file is made available at the source node or a source file is received which is determined to be different from a destination file at the destination node. In this latter embodiment, the source and destination files may be compared to determine whether the files are different so as to initiate a delta operation. A metadata check may determine if the source and destination files contain differences. If a file change is detected, the FM may be created at the destination and transmitted to the source service. The delta is computed at the source node based on the source file and the FM transmitted to the source. As above, only the identified changed data is transferred to the destination node, and the file is updated at the destination node.

Further, unlike the embodiment of FIGS. 1 and 2, the FM need not be saved in memory but may immediately be used to calculate the delta. At source node 302, file F1 is received (block 304). At that time, F1 may be written to memory or transferred immediately over network 320 to destination node 312 (block 314) over the arrows designated A. Subsequently, file F2 is received or made available at source node 302 (block 306). It is determined by any means that F2 is a modified version of F1 or is otherwise a possible candidate for delta compression (e.g., there may be substantial similarities between F1 and F2). Alternatively, upon receiving F2 at the source node, a comparison between F1 at the destination node and F2 at the source node may be made to ascertain whether differences are present in the file. This determination may be made by, among other means, a metadata check as described above. MAP1 is thereupon generated at source node 302 (block 308), and MAP1 may be transferred to destination node 312 via network 320 in addition to F1 (block 316) as represented by the arrow designated B.

In alternative embodiments, MAP1 may be generated on the fly at the destination node and transferred to the source node, such as, for example, in response to determining that F2 at the source node and F2 at the destination node contain differences. Thereupon, —A is calculated (block 310) using MAP1 and F2 (block 310). The Δ is then transmitted via network 320 to destination node 312, where it is used along with F1 to reproduce F2. Subsequently, where a third file is received that is a modified version of the second, the source node 302 or destination node 312 may create MAP2 on the fly corresponding to that file for subsequent delta operations (block 311).

In addition to the advantages associated with the embodiment of FIG. 1, by creating the FM on the fly and processing the FM prior to or in lieu of storing it to memory, the latencies associated with an extra file write may be eliminated, which can accelerate the overall file transfer.

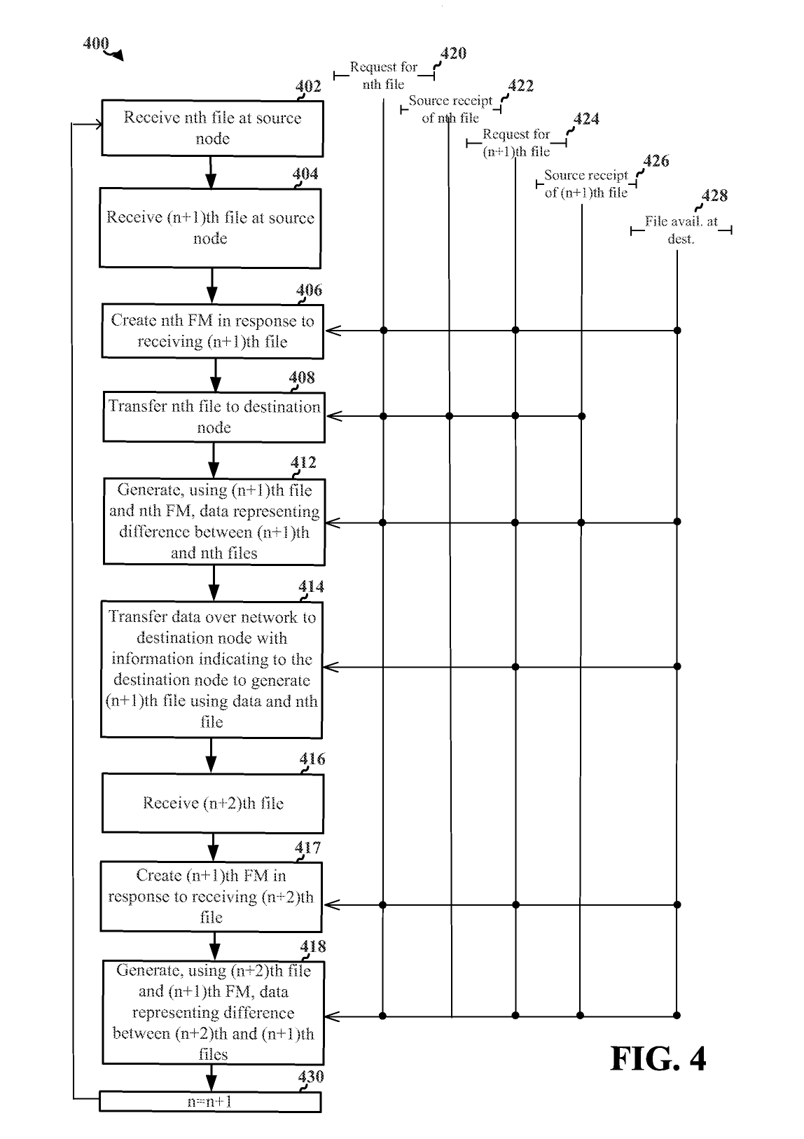

FIG. 4 is a flow diagram 400 illustrating a file transfer using delta differential compression based on on-the-fly mapping. The diagram shown relates to updates or successive iterations of an nₜₕ file. By way of example, a treatise may be periodically updated in electronic form. An nₜₕ file is received at source node 302 (402). Subsequently an (n+1)ₜₕ file is received at source node 302 (404). Following a determination that the files are different, an nₜₕ FM is created corresponding to the nₜₕ file, in response to receiving the (n+1)ₜₕ file (406). The nₜₕ file (and in some embodiments, also the nₜₕ FM) is transferred to destination node 312 (408). The Δ representing the difference between the (n+1)ₜₕ file and the nₜₕ file is generated using the (n+1)ₜₕ file and the nₜₕ FM (414). Subsequently an (n+2)ₜₕ file is received (416), and an (n+1)ₜₕ FM is created in response to receiving the (n+2)ₜₕ file (417). Then the source node 302 generates a new Δ representing a difference between the (n+2)ₜₕ file and the (n+1)ₜₕ file using the (n+2)ₜₕ file and the (n+1)ₜₕ FM (418). The steps may be repeated to accommodate the arrival of new files (430).

In FIG. 4, as shown by the fields 420, 422, 424, 426 and 428 and associated arrow matrix, the various identified steps may be performed in response, for example, to one or more of the events corresponding to these fields, as more specifically described above with reference to FIG. 2 above.

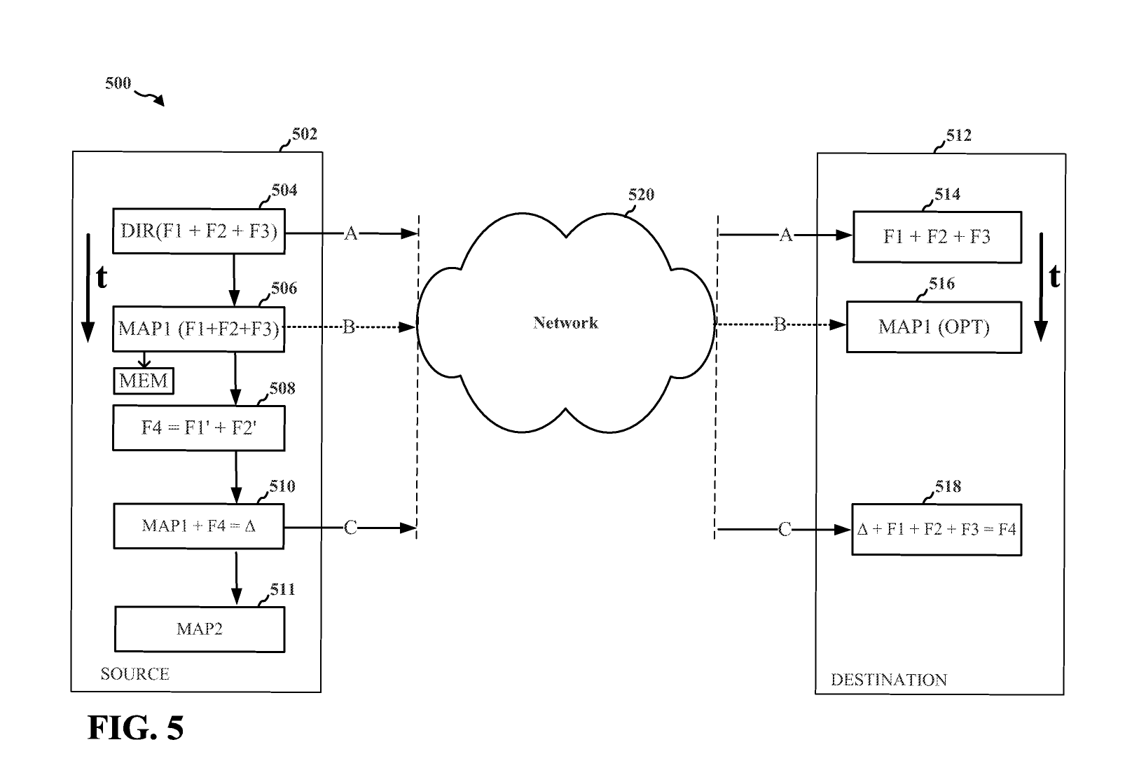

FIG. 5 is a conceptual diagram 500 illustrating a file transfer using delta differential compression based on cumulative mapping. In an embodiment of cumulative mode, an initial set of files is mapped during a transfer. A collective FM of all the files in the set is created. This collective FM may contain reference to all chunks of data and all file paths in the set of files. Subsequently, some subset of the original files may change, as determined by any one of a number of methods. The cumulative Δ of the changed files is obtained. This Δ may contain references to any known chunks across the initial file set. The destination file set is thereupon updated, taking advantage of possible common chunks found in any file of the set. The collective FM is also updated. This technique may have significant benefits if the files in the set contain common chunks.

Referring to FIG. 5, a directory of files F1, F2, F3 is received at the source node 502 (block 504) and transferred via network 520 to destination node 512 as represented by the arrows designated A. A collective or cumulative MAP1 is created corresponding to the files in the directory (block 506), and MAP1 may optionally be provided to the destination node 512 (block 516) via network 520 in addition to the directory of files, as represented by the arrows designated B. Thereupon, at source node 502 a file F4 is received which contains F1′ and F2′ (block 508). F1′ and F2′ contains one or more chunks of F1, and F2′ contains one or more chunks of F2. In other embodiments, file F′ may be received which contains chunks from two or more of files F1, F2, F3, and other, unrelated files. The corresponding Δ is generated using MAP1 and F4, in a manner described herein (block 510). Δ is transferred to destination node 512 via network 520, as represented by the arrows designated C. The destination node next generates F4 using the Δ and the three files F1, F2, F3 (block 518). MAP1 may be updated to MAP2 concurrently at the source node 502 (block 511) to account for the addition of F4.

In alternative embodiments to those shown in FIGS. 1-5, the FM may be computed at the destination node and transmitted back to the source node.

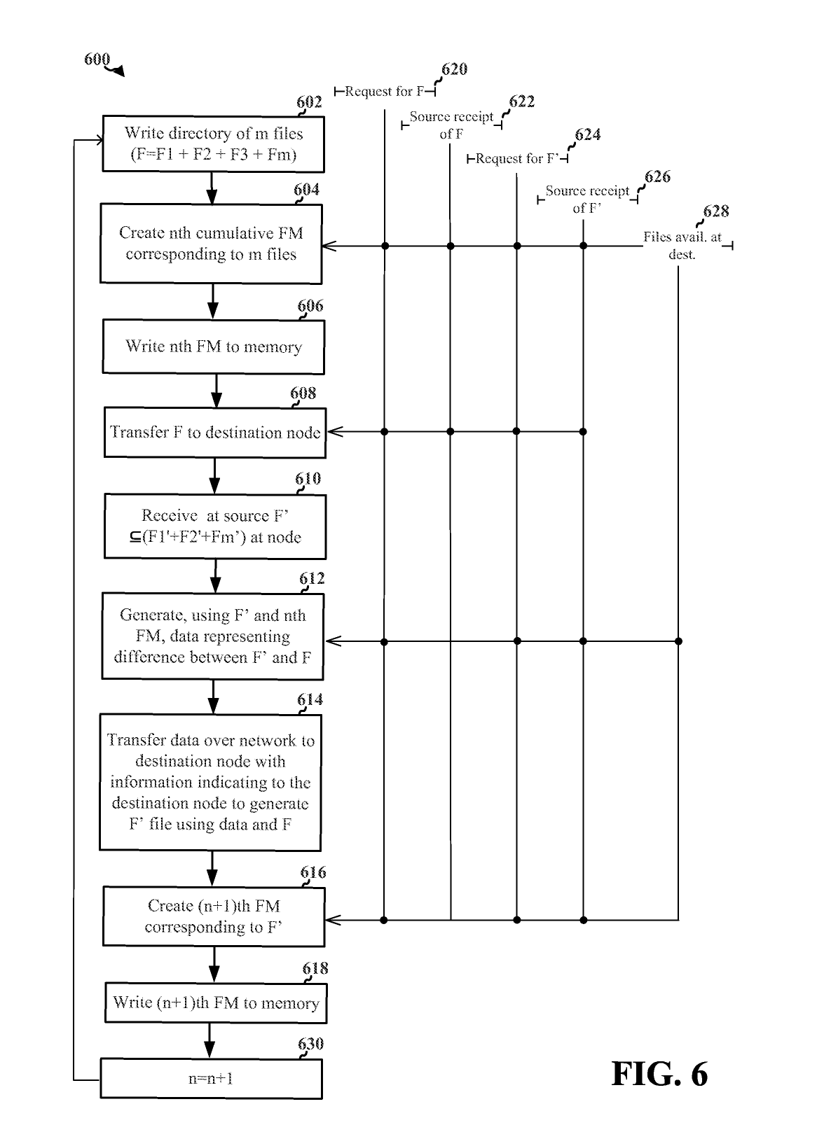

FIG. 6 is a flow diagram 600 illustrating a file transfer using delta differential compression based on cumulative mapping. A set of m files is written to a directory where F=F1+F2+F3+Fm, with m equal to some integer greater than or equal to four (602). An nₜₕ cumulative FM is created corresponding to the initial set of m files (604). In embodiments where F is transferred to the destination node 512, the destination node 512 may create the map corresponding to F and transmit it back to the source node. The nₜₕ FM is written to memory (606), and F (and in some cases the nₜₕ FM) is transferred to the destination node 512 (608). Subsequently the source node 502 receives F′, which in this example is a subset of F1′+F2′+Fm′ (610). Each of F1′, F2′ and Fm′ contain chunks of data from, respectively, F1+F2+Fm. The source node 502 generates, using F′ and the nₜₕ FM, Δ representing a difference between F′ and F (612). The Δ is then transferred over the network to destination node 512 along with an indication to the destination node that the F′ file set can be reproduced using the Δ and F (614). The FM is updated to an (n+1)ₜₕ FM corresponding to F′ (616), and the updated FM is written to memory (618). The process may then continue for subsequent file sets (630).

In FIG. 6, as shown by the fields 620, 622, 624, 626 and 628 and associated arrow matrix, the various identified steps may be performed in response to one or more of the events corresponding to these fields, as more specifically described above with reference to FIG. 2 above.

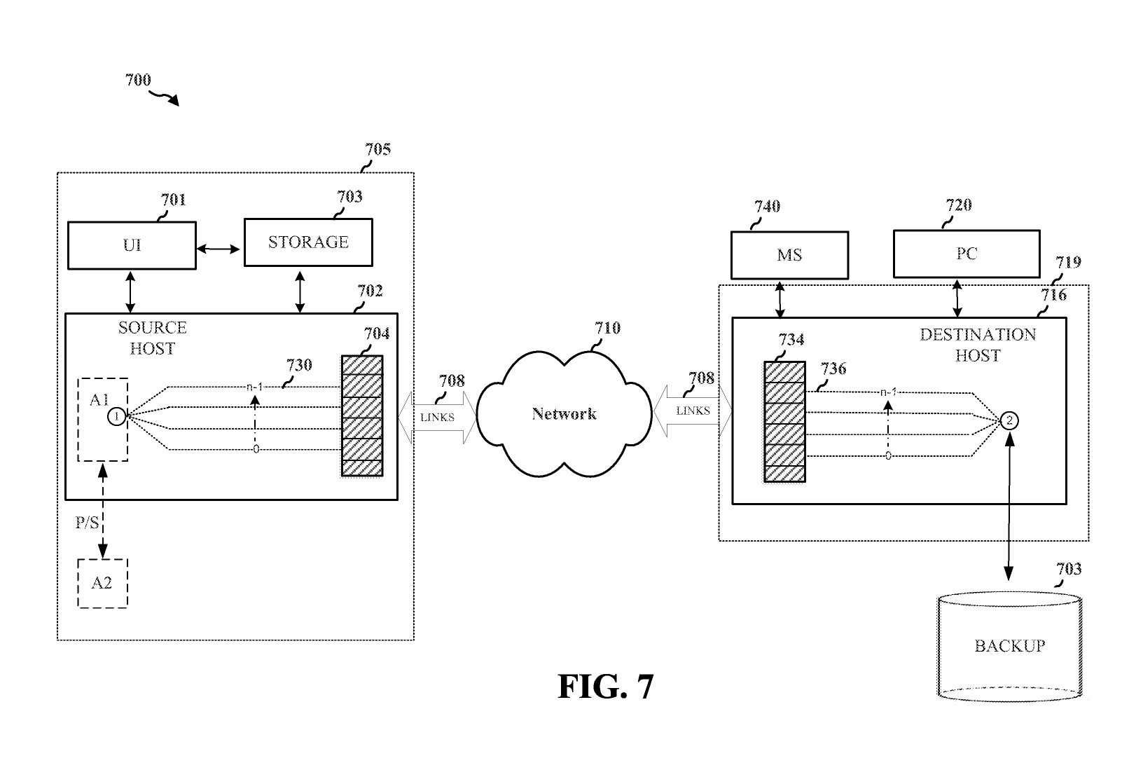

FIG. 7 is a diagram illustrating an engine 700 for effecting file transfers using delta differential operations. A source node 705 may include source host 702, user interface (UI) 701, and storage 705. A destination node 719 may include similar or substantially the same resources as source host 702. An example of such a configuration may include a set of distributed file server nodes across a network. Destination node 719 may include destination host 716 and may be coupled to other peripheral devices for receiving the files, such as mobile station (MS) 740 and personal computing device (PC) 720. Incorporated separately or as part of destination node 719 is backup drive or storage array 703. In one embodiment, the source node 705 and the destination node 719 transfer data over one or more links 708 across a network 710. A1 in this embodiment constitutes a file transfer application employing delta differencing operations as described herein. In one embodiment, file transfer application A1 fragments the data in a set of files to be transferred into n data streams 730, processes and packetizes the data streams using buffer 704 and the processor system of the source host 702, and transmits the resulting packets over links 708 to the destination node 719. At the destination host 716, the results are de-packetized using buffer 734 into n data streams 736 and reconsolidated and reassembled into the original files, represented by 2. The files 2 may then be backed up in a suitable storage array 703.

A2 represents one or more separate applications from which the data constituting the files are obtained. A2 may reside on the same machine or a different machine to that of source host 702. The “P/S” indication shows that the data may be sent via a pipe or socket connection to application A1, or another connection type depending on the physical configuration employed.

FIG. 8 is a diagram illustrating an apparatus 800 for file transfers using delta differential operations. The apparatus includes a processor, which may be implemented as the processing system described above. The apparatus includes memory 804 (which in some configurations may be part of the processing system). Memory 804, in turn, includes a buffer such as ring buffer 806 with separate buffer locations 814, and a main memory such as random access memory 808. The apparatus further includes non-volatile memory/storage 810 (which in some configurations may be part of the processing system), such as a hard drive or storage array. Coupled to the processor 802, memory 804 and non-volatile memory/storage 810 is transceiver 812, which typically contains the electronics and protocol for transmitting and receiving files in the form of data packets over the network 818 and associated links. A separate PC 816 may allow a user to download files received on apparatus 800. The steps described in any of the conceptual diagrams or flow diagrams, and further steps as described in the disclosure herein, may be implemented as one or more software module run on processor 802, one or more firmware modules, or one or more dedicated hardware modules.

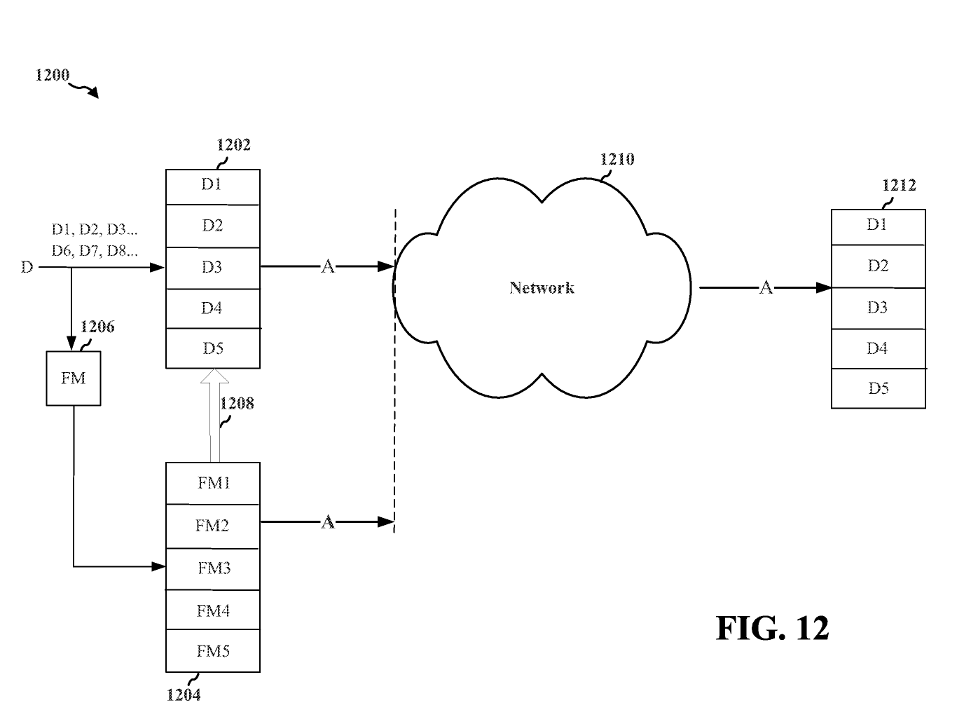

In another aspect of the disclosure, a technique for raw data differencing is disclosed, which can accelerate the transfer of raw data across a network. One use of the technique described in this implementation is an exemplary file transfer engine such as that described in connection with FIG. 7. Source host 702 and destination host 719 may be involved in the transfer of raw data across the network, such that source host 702 has no concept of files or directories and just transfers the unstructured data. In such an embodiment, an on-the-fly technique may be used. Alternatively, a streaming technique may be used as described with reference to FIG. 12.

In FIG. 12, a stream of raw data D is received from an external source at a source host (e.g., source host 702). A predetermined length of the raw data is assembled as a file D1 and stored in a first portion 1202 of a history cache. Concurrently or soon thereafter, FM module 1206 generates a fingerprint map FM1 corresponding to file D1 and/or to packets in file D1, and FM1 is stored in a second portion 1204 of the history cache. The file D1 is sent across the network 1210 over transmission medium A and written to memory 1212 at a destination. Subsequently, from the continued stream D, an additional file D2 may be created and stored in the first portion of the history cache 1202, and FM2 may be created and stored in the second portion 1204 of the history cache. Additional files D3-D5 may be generated and transmitted over network 1210, and so forth. The history cache 1204 may be updated with the storage of additional fingerprint maps F3-F5 until the cache needs to be overwritten with new data.

As new files (e.g. D6, D7, D8) from stream D are generated and stored in the history cache, host 702 compares, via pipe 1208 or a similar interface, the new files to the fingerprint maps (e.g., FM1-FM5) stored in the history cache. If a match is detected, such as if packets in the file are detected to be identical to those represented in one of the stored fingerprint maps, the host 702 transmits an indication to the destination that the file (or particular sections thereof) is already present at the destination and also may send a pointer identifying the file or sections.

As an illustration involving a transfer of a data and a roughly 1 TB history cache 1204, as a first 100 MB of data arrives at the host 702, the history cache 1204 may be empty. After 1 TB of data is received, the host may create a 1 TB file constituting the data and a fingerprint map of the file. The file and fingerprint map may be stored in the history cache at the host. As additional data is received beyond the 1 TB, the data may be identified to correspond with one of the stored maps, whereupon the source 702 sends an appropriate indication over the network. It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for file transfers; comprising:
a memory having a first file stored therein;
a processor coupled to the memory and configured to create a first fingerprint map (FM) corresponding to the first file, write the first FM to the memory, and generate, using a second file and the first FM, data representing a difference between the first file and the second file, wherein the data and the first file are sufficient to generate the second file; and
a transceiver configured to transmit the data and the first file over a network to a destination node.

2. The apparatus of claim 1, wherein the processor is configured to write the first file to the memory and create the first FM in response to receiving the first file.

3. The apparatus of claim 1, wherein the processor is configured to create the first FM in response to receiving the second file.

4. The apparatus of claim 1, wherein the second file comprises a modified version of the first file.

5. The apparatus of claim 1, wherein the processor is configured to generate the data in response to receiving the second file.

6. The apparatus of claim 1, wherein the processor is configured to generate the data in response to a request to transfer the second file to the destination node.

7. The apparatus of claim 1, wherein the processor is configured to generate the data in response to a determination that the first file is available at the destination node.

8. The apparatus of claim 1, wherein the processor is configured to generate the data in response to a determination that the second file comprises a modified version of the first file.

9. The apparatus of claim 1 wherein the processor is configured to transfer, in response to a request to transfer the first file or the first FM to the destination node, the first FM over the network via the transceiver to the destination node.

10. The apparatus of claim 9, wherein the transceiver is configured to transmit, in response to a request to transfer the second file to the destination node, the data over the network to the destination node.

11. The apparatus of claim 1, wherein the data comprises an indication to the destination node that the second file can be generated based on the data and the first file.

12. The apparatus of claim 1, wherein the processor is configured to create a second FM corresponding to the second file and write the second FM to the memory.

13. The apparatus of claim 12, wherein the processor is configured to create the second FM in response to one of receiving the second file or receiving a new file.

14. The apparatus of claim 13, wherein the processor is configured to generate, using the new file and the second FM, new data representing a difference between the second file and the new file.

15. The apparatus of claim 14, wherein the transceiver is configured to transmit the new data over the network to the destination node.

16. The apparatus of claim 13, wherein the new file comprises a modified version of the second file.

17. The apparatus of claim 14, wherein the processor is configured to generate the new data in response to a determination that the new file is a modified version of the second file.

18. The apparatus of claim 14, wherein the processor is configured to generate the new data in response to a determination that the second file is available at the destination node.

19. An apparatus for file transfers, comprising:
a memory having a plurality of files stored therein;
a processor coupled to the memory and configured to create a cumulative fingerprint map (FM) corresponding to the plurality of files; write the cumulative FM into the memory; and generate, using the cumulative FM and at least one file separate from the plurality of files, data representing a difference between the plurality of files and the at least one separate file, wherein the data and the plurality of files are sufficient to generate the at least one separate file; and
a transceiver configured to transmit the data and the plurality of files over a network to a destination node.

20. The apparatus of claim 19, wherein the memory comprises a directory structure, and the directory structure identifies a directory comprising the plurality of files.

21. The apparatus of claim 19, wherein the processor is configured to receive the plurality of files, write the plurality of files to the memory, and create the cumulative FM in response to receiving the plurality of files.

22. The apparatus of claim 19, wherein the processor is configured to create the cumulative FM in response to receiving the at least one separate file.

23. The apparatus of claim 19, wherein the at least one separate file comprises a modified version of the plurality of files.

24. The apparatus of claim 19, wherein the processor is configured to generate the data in response to a request to transfer the at least one separate file to the destination node.

25. The apparatus of claim 19, wherein the processor is configured to generate the data in response to a determination that the plurality of files are available at the destination node.

26. The apparatus of claim 19, wherein the transceiver is further configured to transmit, in response to a request to transfer the plurality of files to the destination node, at least the plurality of files or the cumulative FM to the transceiver for transmission over the network to the destination node.

27. The apparatus of claim 19, wherein the transceiver is configured to transmit the data over the network to the destination node in response to a request to transfer the at least one separate file to the destination node.

28. The apparatus of claim 27, wherein the data comprises an indication to the destination node that the at least one separate file can be generated based on the data and the plurality of files.

29. The apparatus of claim 19, wherein the processor is configured to receive at least one additional file, and create an updated cumulative FM corresponding to the at least one additional file

30. The apparatus of claim 29, wherein the processor is configured to create the updated cumulative FM in response to a determination that the at least one separate file is available at the destination node.

31. The apparatus of claim 29, wherein the processor is configured to generate, using the updated cumulative FM and the at least one separate file, new data representing a difference between the at least one additional file and the at least one separate file; wherein the new data and the at least one separate file are sufficient to generate the file.

32. The apparatus of claim 31, wherein the transceiver is configured to transmit the new data over the network to the destination node.

33. The apparatus of claim 19, wherein the processor is configured to create the cumulative FM in response to receiving the plurality of files.

34. The apparatus of claim 19, wherein the processor is configured to generate the data in response to receiving the at least one separate file.

35. The apparatus of claim 19, wherein the processor is configured to generate the data in response to a request to transfer the at least one separate file to the destination node.

36. The apparatus of claim 19, wherein the processor is configured to generate the data in response to a determination that the plurality of files are available at the destination node.

37. The apparatus of claim 19, wherein the processor is configured to generate the data in response to a determination that the at least one separate file comprises a modified version of the plurality of files.

38. A computer program product comprising a non-transitory computer-readable medium having computer executable code for:
creating a first fingerprint map (FM) corresponding to a first file;
writing the first FM to a memory;
generating, using a second file and the first FM, data representing a difference between the first file and the second file, wherein the data and the first file are sufficient to generate the second file; and
transmitting the data and the first file via a transceiver over a network to a destination node.

39. The computer program product of claim 38, further comprising code for writing the first file to the memory and creating the first FM in response to receiving the first file.

40. The computer program product of claim 38, further comprising code for creating the first FM in response to receiving the second file.

41. The computer program product of claim 38, wherein the second file comprises a modified version of the first file.

42. The computer program product of claim 38, further comprising code for generating the data in response to receiving the second file.

43. The computer program product of claim 38, further comprising code for generating the data in response to a request to transfer the second file to the destination node.

44. The computer program product of claim 38, further comprising code for generating the data in response to a determination that the first file is available at the destination node.

45. The computer program product of claim 38, further comprising code for generating the data in response to a determination that the second file comprises a modified version of the first file.

46. The computer program product of claim 38, further comprising code for transferring, in response to a request to transfer the first file or the first FM to the destination node, the first FM over the network via the transceiver to the destination node.

47. The computer program product of claim 46, further comprising code for transmitting, in response to a request to transfer the second file to the destination node, the data over the network to the destination node.

48. The computer program product of claim 38, wherein the data comprises an indication to the destination node that the second file can be generated based on the data and the first file.

49. The computer program product of claim 38, further comprising code for creating a second FM corresponding to the second file and writing the second FM to the memory.

50. The computer program product of claim 49, further comprising code for creating the second FM in response to one of receiving the second file or receiving a new file.

51. The computer program product of claim 38, further comprising code for generating, using the new file and the second FM, new data representing a difference between the second file and the new file.

52. The computer program product of claim 51, further comprising code for transmitting the new data over the network to the destination node.

53. The computer program product of claim 50, wherein the new file comprises a modified version of the second file.

54. The computer program product of claim 51, further comprising code for generating the new data in response to a determination that the new file is a modified version of the second file.

55. The computer program product of claim 51, further comprising code for generating the new data in response to a determination that the second file is available at the destination node.

56. A computer program product comprising a non-transitory computer-readable medium having computer executable code for:
creating a cumulative fingerprint map (FM) corresponding to a plurality of files;
writing the cumulative FM into a memory;
generating, using the cumulative FM and at least one file separate from the plurality of files, data representing a difference between the plurality of files and the at least one separate file, wherein the data and the plurality of files are sufficient to generate the at least one separate file; and
transmitting the data and the plurality of files via a transceiver over a network to a destination node.

57. The computer program product of claim 56, wherein the memory comprises a directory structure, and the directory structure identifies a directory comprising the plurality of files.

58. The computer program product of claim 56, further comprising code for writing the plurality of files to the memory and creating the cumulative FM in response to receiving the plurality of files.

59. The computer program product of claim 56, further comprising code for creating the cumulative FM in response to receiving the at least one separate file.

60. The computer program product of claim 56, wherein the at least one separate file comprises a modified version of the plurality of files.

61. The computer program product of claim 56, further comprising code for generating the data in response to a request to transfer the at least one separate file to the destination node.

62. The computer program product of claim 56, further comprising code for generating the data in response to a determination that the plurality of files are available at the destination node.

63. The computer program product of claim 56, further comprising code for transmitting, in response to a request to transfer the plurality of files to the destination node, at least the plurality of files or the cumulative FM via the transceiver over the network to the destination node.

64. The computer program product of claim 56, further comprising code for transmitting the data via the transceiver over the network to the destination node in response to a request to transfer the at least one separate file to the destination node.

65. The computer program product of claim 64, wherein the data comprises an indication to the destination node that the at least one separate file can be generated based on the data and the plurality of files.

66. The computer program product of claim 56, further comprising code for receiving at least one additional file, and creating an updated cumulative FM corresponding to the at least one additional file

67. The computer program product of claim 66, further comprising code for creating the updated cumulative FM in response to a determination that the at least one separate file is available at the destination node.

68. The computer program product of claim 66, further comprising code for generating, using the updated cumulative FM and the at least one separate file, new data representing a difference between the at least one additional file and the at least one separate file, wherein the new data and the at least one separate file are sufficient to generate the file.

69. The computer program product of claim 68, further comprising code for transmitting the new data via the transceiver over the network to the destination node.

70. The computer program product of claim 56, further comprising code for creating the cumulative FM in response to receiving the plurality of files.

71. The computer program product of claim 56, further comprising code for generating the data in response to receiving the at least one separate file.

72. The computer program product of claim 56, further comprising code for generating the data in response to a request to transfer the at least one separate file to the destination node.

73. The computer program product of claim 56, further comprising code for generating the data in response to a determination that the plurality of files are available at the destination node.

74. The computer program product of claim 56, further comprising code for generating the data in response to a determination that the at least one separate file comprises a modified version of the plurality of files.
